(19) United States
(12) Patent Application Publication
(10) Pub. No.: US 2013/0308837 A1
(43) Pub. Date: Nov. 21, 2013

(54) INFORMATION PROCESSOR, INFORMATION PROCESSING METHOD, AND PROGRAM

(71) Applicant: SONY CORPORATION, Tokyo (JP)

(72) Inventor: Hiroshi Abe, Tokyo (JP)

(73) Assignee: Sony Corporation, Tokyo (JP)

(21) Appl. No.: 13/890,534

(22) Filed: May 9, 2013

(30) Foreign Application Priority Data
May 16, 2012 (JP) 2012-112459

(51) Int. Cl. G06K 9/00

(52) U.S. Cl. CPC G06K 9/00228
USPC 382/118

(57) ABSTRACT

An information processor includes: a face direction detecting section detecting directions of a face from images in which said face of a subject to registration becoming a subject of registration is photographed; a peripheral direction determination processing section determining the images for which the directions of the face detected by the face direction detecting section are determined to be within a specified range of a predetermined peripheral direction other than a front surface direction as registration candidates of the peripheral direction; and a direction dispersion determination processing section determining the predetermined sheets of images, for which the directions of the face are sufficiently, mutually dispersed, of the images determined as the registration candidates by the peripheral direction determination processing section as the images for registration of the peripheral direction.

### BACKGROUND

The present disclosure relates to an information processor, an information processing method used in the same, and a program used in the same. More particularly, the present disclosure relates to an information processor which is capable of readily acquiring a face image used to stably carry out face authentication, an information processing method used in the same, and a program used in the same.

In recent years, a face authentication system for registering plural sheets of face images for the same face for the purpose of carrying out stable face authentication has been widely used.

For example, processing for picking up given sheets of face images, and registering the given sheets of face images thus picked up for a given period of time has been executed in the existing face authentication system. In such processing in the existing face authentication system, however, the face image obtained by picking up a front face which is most important when the face authentication is carried out is not acquired, or plural sheets of face images in which directions of the face are not dispersed, and thus the face is directed in fixed directions are registered in some cases.

On the other hand, for registering a face image in which the face faces the front, and plural face images in which the directions of the face are dispersed, a subject to registration needs to be strictly instructed to the desired direction(s). However, it may be impossible to register a desired image or it takes a lot of time to carry out the registration of face images depending on the level of skill of a person who issues an instruction for the direction of the subject to registration (such as a registration indicator or an application for carrying out the registration) in some cases.

In such a manner, with the existing face authentication system, it may be impossible to acquire the face image having an excellent authentication precision with which the stable face authentication can be carried out in some cases.

On the other hand, Japanese Patent Laid-Open No. 2009-258991 proposes a face image register adopting a configuration in which, for example, an instructing portion for registering an image to be registered is prepared, and an instruction to change of a direction of a face is issued.

### SUMMARY

However, with the face image register, which issues the instruction to change the direction of the face, as disclosed in Japanese Patent Laid-Open No. 2009-258991, it is possible that the level of the skill of the register itself is influenced. For this reason, it is desired to stably acquire the face image with which the stable face authentication can be carried out.

The present disclosure has been made in order to solve the problems described above, and it is therefore desirable to provide an information processor which is capable of readily acquiring a face image used to stably carry out face authentication, an information processing method used in the information processor, and a program used in the information processor.

In order to attain the desire described above, according to one mode of the present disclosure, there is provided an information processor including: a face direction detecting section configured to detect directions of a face from images in which the face of a subject to registration becoming a subject of registration is photographed; a peripheral direction determination processing section configured to determine the images for which the directions of the face detected by the face direction detecting section are determined to be within a specified range of a predetermined peripheral direction other than a front surface direction as registration candidates of the peripheral direction; and a direction dispersion determination processing section configured to determine the predetermined sheets of images, for which the directions of the face are sufficiently, mutually dispersed, of the images determined as the registration candidates by the peripheral direction determination processing section as the images for registration of the peripheral direction.

According to another mode of the present disclosure, there is provided an information processing method including: detecting directions of a face from images in which the face of a subject to registration becoming a subject of registration is photographed; determining the images for which the directions of the face detected are determined to be within a specified range of a predetermined peripheral direction other than a front surface direction as registration candidates of the peripheral direction; and determining the predetermined sheets of images, for which the directions of the face are sufficiently, mutually dispersed, of the images determined as the registration candidates as the images for registration of the peripheral direction.

According to still another mode of the present disclosure, there is provided a program for causing a computer to execute a process including: detecting directions of a face from images in which the face of a subject to registration becoming a subject of registration is photographed; determining the images for which the directions of the face detected are determined to be within a specified range of a predetermined peripheral direction other than a front surface direction as registration candidates of the peripheral direction; and determining the predetermined sheets of images, for which the directions of the face are sufficiently, mutually dispersed, of the images determined as the registration candidates as the images for registration of the peripheral direction.

In the modes of the present disclosure, the directions of the face are detected from the images in which the face of the subject to registration becoming the subject of the registration is photographed. The images for which the directions of the face are determined to be within the specified range of the predetermined peripheral direction other than the front direction are determined as the registration candidates of the peripheral direction. Also, of the images which are determined as the registration candidates of the peripheral direction, the predetermined sheets of images for which the directions of the face are determined to be sufficiently, mutually dispersed are determined as the images for the registration of the peripheral direction.

As set forth hereinabove, according to the present disclosure, it is possible to readily acquire the face images based on which the face authentication is stably carried out.

### BRIEF DESCRIPTION OF THE DRAWINGS

FIG. 1 is a block diagram showing an exemplary configuration of an information processor according to one embodiment of the present disclosure;

FIG. 2 is a view explaining a direction of a face of a subject to registration;

FIG. 3 is a diagram explaining front direction determination processing;

FIG. 4 is a diagram explaining peripheral direction determination processing;

FIG. 5 is a diagram explaining a convex hull;

FIG. 6 is a diagram explaining update of the convex hull;

FIGS. 7A and 7B are respectively diagrams explaining an area of the convex hull;

FIG. 8 is a flow chart explaining face data registering processing;

FIG. 9 is a flow chart explaining front direction determination processing;

FIG. 10 is a flow chart explaining another example of the front direction determination processing;

FIG. 11 is a flow chart explaining peripheral direction determination processing;

FIG. 12 is a flow chart explaining direction dispersion determination processing;

FIG. 13 is a view explaining visualization of a face direction of a face image which is being registered; and

FIG. 14 is a block diagram showing an exemplary configuration of a computer to which the present disclosure is applied.

### DETAILED DESCRIPTION OF THE PREFERRED EMBODIMENT

Hereinafter, one embodiment of the present disclosure will be described in detail with reference to the accompanying drawings.

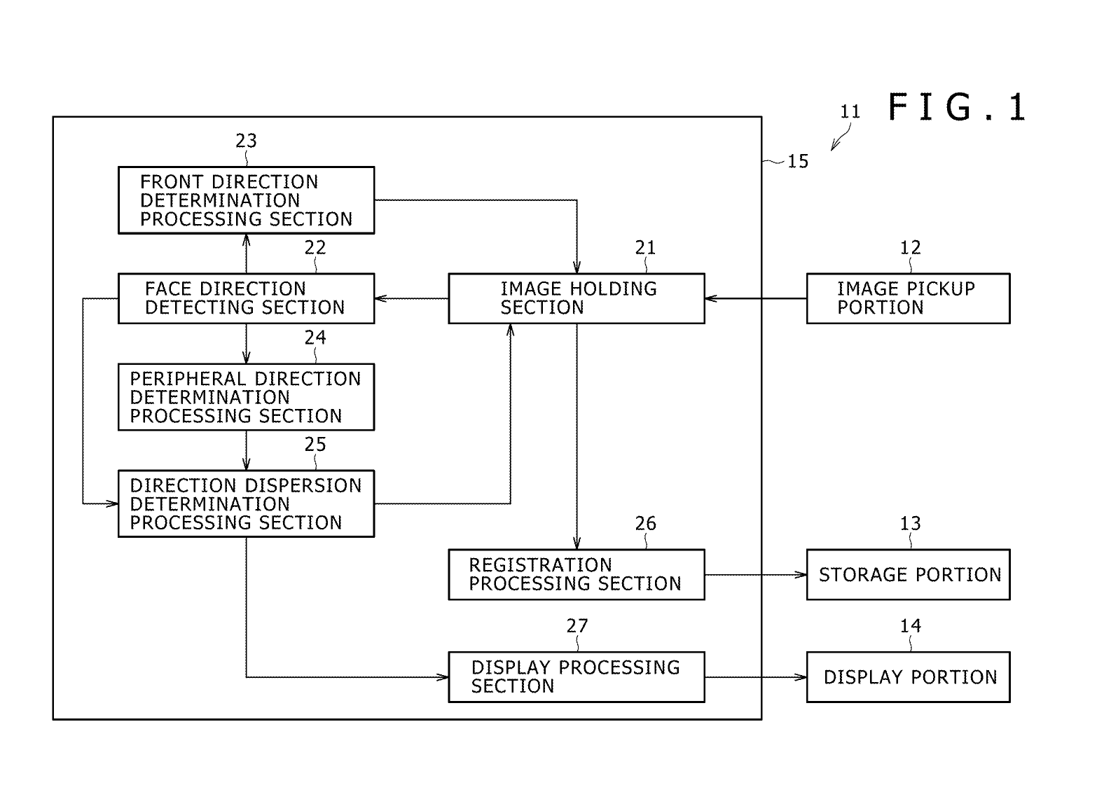

FIG. 1 is a block diagram showing an exemplary configuration of an information processor according to one embodiment of the present disclosure.

Referring to FIG. 1, an information processor 11 is composed of an image picking up portion 12, a storage portion 13, a display portion 14, and a face data registration processing portion 15. Also, the information processor 11 executes face data registering processing for registering face data which is referred in face recognizing processing.

The image pickup portion 12 is composed of an image pickup element such as a Charge Coupled Device (CCD) or a Complementary Metal Semiconductor (CMOS) sensor. The image pickup portion 12 continuously picks up images of a face of a subject to registration becoming a subject of registration of face data. Also, the image pickup portion 12 supplies the data on the images in which the face of the subject to registration is photographed (hereinafter suitably referred to as “face images”) to the face data registration processing portion 15.

The storage portion 13, for example, is composed of a hard disk drive, a flash memory (for example, an Electronically Erasable and Programmable Read Only Memory (EEPROM)) or the like. Also, the storage portion 13 stores therein the face data supplied thereto from the face data registration processing portion 15.

The display portion 14, for example, is composed of a liquid crystal panel, an organic Electro Luminescence (EL) panel or the like. Also, the display portion 14 displays thereon a message, an image or the like for the subject to registration when the face data registering processing is executed by the face data registration processing portion 15. For example, the display portion 14 displays thereon a message representing the effect that images of a face in the front direction and in an arbitrary direction should be continuously picked up for the subject to registration.

The face data registration processing portion 15 is composed of a Central Processing Unit (CPU) and a memory. Also, the face data registration processing portion 15 executes face data registering processing for registering face data obtained from the face images of the subject to registration by executing a program stored in the memory by the CPU. For example, the face data registration processing portion 15 determines both of the face image in which the subject to registration in a state he/she faces the front for the image pickup portion 12 is photographed, and predetermined sheets of face images in which the face in a state in which the subject to registration faces the peripheral direction (an arbitrary direction other than the front direction) for the image pickup portion 12 are photographed in the face data registering processing as the face images for registration. Also, the face data registration processing portion 15 registers the face data (template data) composed of an amount of features of the face photographed in these face images for registration.

As shown in FIG. 1, the face data registration processing portion 15 is composed of an image holding section 21, a face direction detecting section 22, a front direction determination processing section 23, a peripheral direction determination processing section 24, a direction dispersion determination processing section 25, a registration processing section 26, and a display processing section 27.

The image holding section 21 holds therein data, on the face images, which is continuously supplied thereto from the image pickup portion 12. In the face data registration processing portion 15, whenever the data on a new face image is supplied from the image pickup portion 12 to the image holding section 21, processing is executed with the new face image as an object of determination.

The face direction detecting section 22 reads out the data on the face image becoming the object of determination from the image holding section 21 and carries out an image analysis for the face image concerned, thereby detecting a direction of the face of the subject to registration who is photographed in the face image.

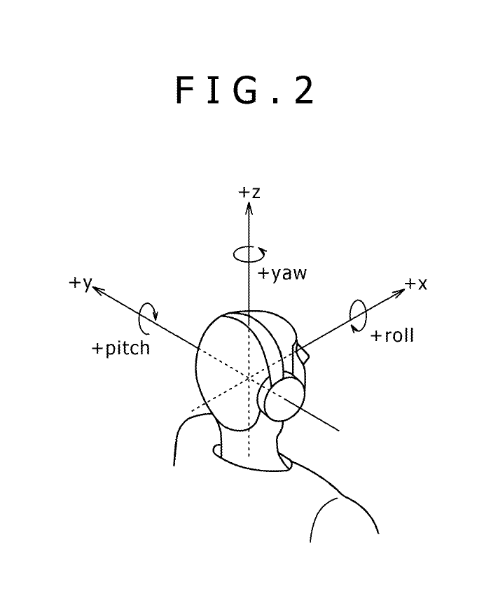

For example, the face direction detecting section 22, as shown in FIG. 2, detects a pitch value p, representing an angle of the face in a pitch direction, a yaw value y, representing an angle of the face in a yaw direction, and a roll value r, representing an angle of the face in a roll direction in the form of a direction of the face of the subject to registration. That is to say, the face direction detecting section 22 obtains a set of pitch value p, yaw value y, and roll value r, for one sheet of face image. It is noted that in the case shown in FIG. 2, the image pickup portion 12 of the information processor 11 is disposed in the front direction (in the x-axis direction) of the face of the subject to registration. Thus, when the subject to registration precisely faces the front and his/her face is not inclined, each of the pitch value p, the yaw value y, and the roll value r, becomes zero. Here, in the present embodiment of the present disclosure, a description will now be given with respect to processing for determining the direction of the face by using both of the pitch value p, and the yaw value y.

Also, the face direction detecting section 22 arithmetically operates a sum of squares of the pitch value p, and the yaw value y, which are detected from the face image as the subject of determination to obtain a direction scale D² (D²=p²+y²), thereby supplying the direction scale D² to each of the front direction determination processing section 23 and the peripheral direction determination processing section 24.

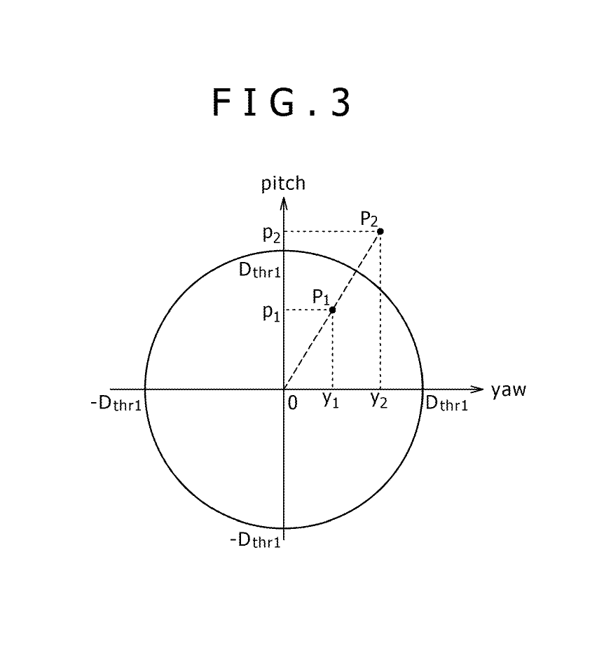

The front direction determination processing section 23 executes a front face direction determination processing for determining whether or not the face of the subject to registration in the face image as the object of determination faces the front direction based on the direction scale D² supplied thereto from the face direction detecting section 22. When it is determined in the front direction determination processing that the subject to registration faces the front direction, the front direction determination processing section 23 causes the image holding section 21 to preserve therein data on the face image as the object of determination as a registration candidate of the front direction. It is noted that the front direction determination processing will be described later with reference to FIG. 3.

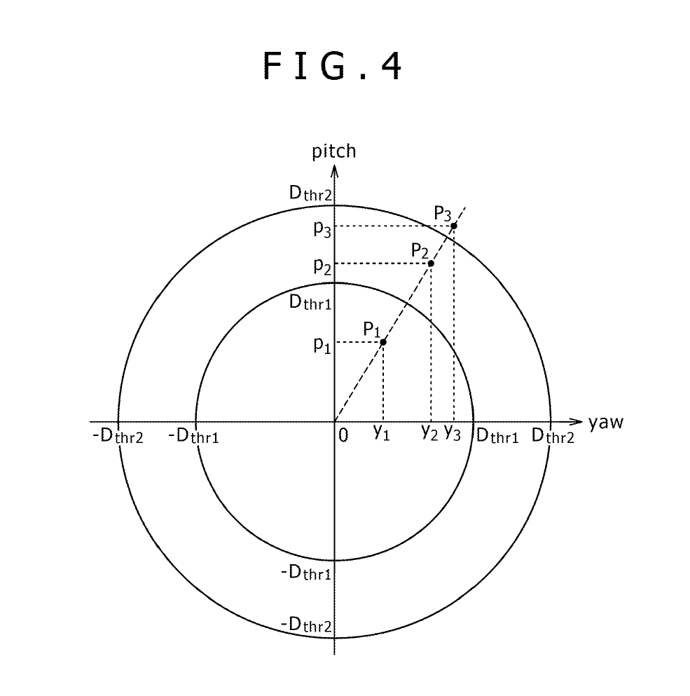

The peripheral direction determination processing section 24 executes peripheral direction determination processing for determining whether or not the direction of the face of the subject to registration in the face images as the object of determination is within a specified range of a suitable peripheral direction which is such that the recognition precision is not reduced in the face recognition based on the direction scale D² supplied thereto from the face direction detecting section 22. When it is determined in the peripheral direction determination processing that the direction of the face of the subject to registration is within the specified range of the suitable peripheral direction, the peripheral direction determination processing section 24 determines the face image as the subject of determination as the registration candidate of the peripheral direction. It is noted that the peripheral direction determination processing will be described later with reference to FIG. 4.

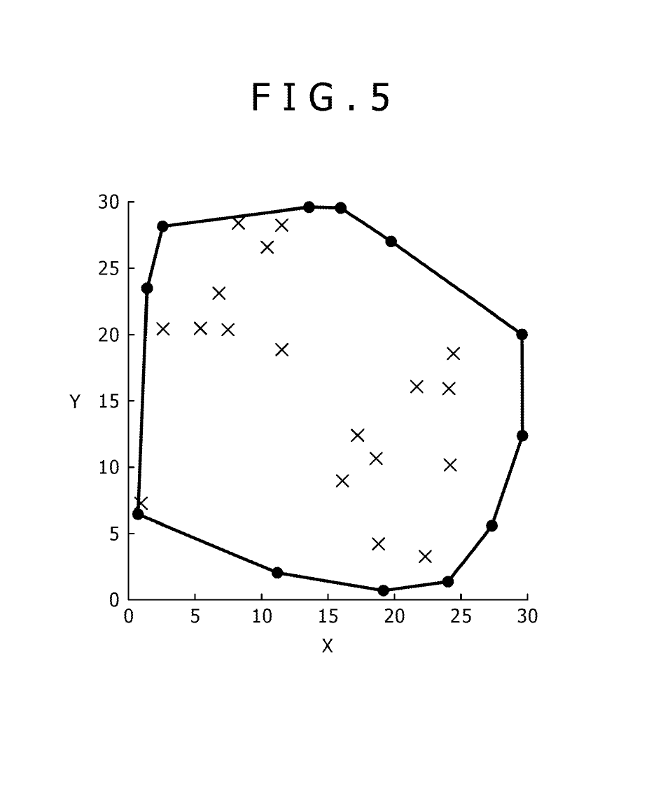

When the peripheral direction determination processing section 24 newly determines the face image as the subject of determination as the registration candidate of the peripheral direction, the direction dispersion determination processing section 25 reads out both of the pitch value p, and the yaw value y, of the face image concerned from the face direction detecting section 22. Also, the direction dispersion determination processing section 25 executes direction dispersion determination processing for determining whether or not the pitch value p, and the yaw value y, thus read out are compared with the pitch values p, and the yaw values y, of the face images determined as the registration candidates of other peripheral directions, respectively and as a result, the directions of the face of the subject to registration in these face images are mutually, sufficiently dispersed. It is noted that the direction dispersion determination processing will be described later with reference to FIG. 5 to FIGS. 7A and 7B.

The direction dispersion determination processing section 25 determines predetermined sheets of face images, for which the directions of the face of the subject to registration are determined to be mutually, sufficiently dispersed in the direction dispersion determination processing, of the face images determined as the registration candidates of the peripheral direction as the face images for registration of the peripheral direction, an causes the image holding section 21 to preserve therein the data on the predetermined sheets of face images concerned.

When the direction dispersion determination processing section 25 determines the face images for registration of the peripheral direction, both of the data on these face images, and the data on the face images which are preserved as the registration candidates of the front direction at that time point are supplied from the image holding section 21 to the registration processing section 26. Also, the registration processing section 26 calculates an amount of features of the face of the subject to registration from the data on the face images which is supplied thereto from the image holding section 21, and supplies the face data on the amount of features to the storage portion 13 and causes the storage portion 13 to store therein the face data on the amount of features concerned.

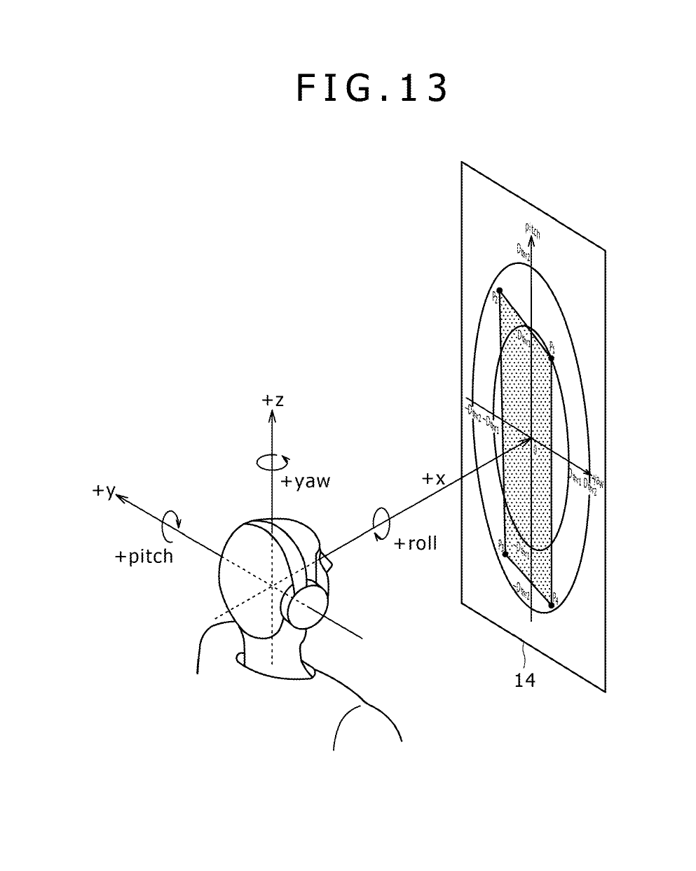

While the face data registering processing is executed in the face data registration processing portion 15, the display processing section 27 causes the display portion 14 to display thereon a message representing the effect that, for example, the faces in the front direction and in arbitrary direction are continuously photographed. In addition, the display processing section 27, for example, reads out the data on the directions of the face which are determined to be mutually, sufficiently dispersed in the direction dispersion determination processing from the direction dispersion determination processing section 25, and visualizes the data on the directions of the face thus read out, thereby displaying thereon the images corresponding to the data concerned (as described hereinbelow with reference to FIG. 13).

Next, a description will now be given with respect to the front direction determination processing executed by the front direction determination processing section 23 with reference to FIG. 3.

The front direction determination processing section 23 compares the direction scale D² supplied thereto from the face direction detecting section 22 with a first direction scale threshold value D²ₜₕᵣ₁ previously set.

When the direction scale D² is smaller than the first direction scale threshold value D²ₜₕᵣ₁ (D²<D²ₜₕᵣ₁), the front direction determination processing section 23 determines that the subject to registration faces the front direction. That is to say, as shown in FIG. 3, when a point P₁ represented by both of the pitch value p₁, and the yaw value y₁, which are detected from the face image by the face direction detecting section 22, is located inside a circle having the square root (Dₜₕᵣ₁) Of the first direction scale threshold value D ²ₜₕᵣ₁ as a radius, it is determined that the direction of the face represented by the point P₁ is the front direction.

On the other hand, when the direction scale D² is equal to or larger than the first direction scale threshold value D²ₜₕᵣ₁ (D²≧D²ₜₕᵣ₁), the front direction determination processing section 23 determines that the subject to registration does not face the front direction. That is to say, as shown in FIG. 3, when a point P₂ represented by both of a pitch value p₂, and a yaw value y₂, which are detected from the face image by the face direction detecting section 22, is located outside the circle having the square root (Dₜₕᵣ₁) of the first direction scale threshold value D²ₜₕᵣ₁ as the radius, it is determined that the direction of the face represented by the point P₂ is not the front direction.

In such a manner, when the direction of a face (the point P represented by both of the pitch value and the yaw value) which is detected from the face image is present inside the circle having the square root (Dₜₕᵣ₁) of the first direction scale threshold value D₂ₜₕᵣ₁ as the radius, the front direction determination processing section 23 determines in the front direction determination processing that the direction of the face is the front direction.

It is noted that, for example, whenever the face image is picked up by the image pickup portion 12, the front direction determination processing section 23 can execute the front direction determination processing. Alternatively, after once the registration candidate of the front direction has been determined, the front direction determination processing section 23 can omit the front direction determination processing.

Next, a description will now be given with respect to the peripheral direction determination processing executed by the peripheral direction determination processing section 24, with reference to FIG. 4.

The peripheral direction determination processing section 24 compares the direction scale D² supplied thereto from the direction detecting portion 22 with each of the first direction scale threshold value D₂ₜₕᵣ₁, and a second direction scale threshold value D²ₜₕᵣ₂ which are previously set. It is noted that since the second direction scale threshold value D₂ₜₕᵣ₂ is not used to determine the front direction, as shown in FIG. 4, the second direction scale threshold value D²ₜₕᵣ₂ is set to a larger value than the first direction scale threshold value D²ₜₕᵣ₁ (D²ₜₕᵣ₂>D²ₜₕᵣ₁).

Also, when the direction scale D² is equal to or larger than the first direction scale threshold value D²ₜₕᵣ₁ and is smaller than the second direction scale threshold value D²ₜₕᵣ₂ (D²ₜₕᵣ₁≦D²<D²ₜₕᵣ₂), the peripheral direction determination processing section 24 determines that the direction of the face of the subject to registration is within the suitable specified range of the peripheral direction which is such that the recognition precision is not reduced in the face recognition. That is to say, as shown in FIG. 4, when the point P₂ represented by both of the pitch value p₂, and the yaw value y₂, which are detected from the face image by the face direction detecting section 22, is located outside the circle having the square root (Dₜₕᵣ₁) of the first direction scale threshold value D₂ₜₕᵣ₁ as the radius, and is located inside the circle having the square root (Dₜₕᵣ₂) of the second direction scale threshold value D²ₜₕᵣ₂ as the radius, the peripheral direction determination processing section 24 determines that the direction of the face represented by the point P₂ is within the specified range.

On the other hand, when the direction scale D² is equal to or larger than the second direction scale threshold value D²ₜₕᵣ₂ (D²≧D²ₜₕᵣ₂), the peripheral direction determination processing section 24 determines that the direction of the face of the subject to registration is not within the suitable specified range of the peripheral direction which is such that the recognition precision is not reduced in the face recognition. That is to say, as shown in FIG. 4, when a point P₃ represented by both of a pitch value p₃, and a yaw value y₃, which are detected from the face image by the face direction detecting section 22, is located outside the circle having the square root (Dₜₕᵣ₂) of the second direction scale threshold value D²ₜₕᵣ₂ as the radius, the peripheral direction determination processing section 24 determines that the direction of the face represented by the point P₃ is not within the specified range.

In such a manner, the peripheral direction determination processing section 24 excludes the face image having such a face direction that the direction scale D² is equal to or larger than the second direction scale threshold value D²ₜₕᵣ₂, that is, the face image having the face direction which largely deviates from the front of the face from the face images which are picked up by using the image pickup portion 12.

Next, a description will now be given with respect to the direction dispersing determination processing executed by the direction dispersion determination processing section 25 with respect to FIG. 5 to FIGS. 7A and 7B.

The direction dispersion determination processing section 25 reads out both of the pitch value p, and the yaw value y, obtained from the face image for which the peripheral direction determination processing section 24 determines that the direction of the face of the subject to registration is within the suitable specified range of the peripheral direction from the face direction detecting section 22. Also, the direction dispersion determination processing section 25 carries out a convex hull calculation for obtaining a convex hull which is formed by the coordinate points represented by both of the pitch values p, and the yaw values y.

Here, as shown in FIG. 5, the direction dispersion determination processing section 25 determines a set of coordinate points becoming apices of a polygon when in the X-Y plane in which plural coordinate points are plotted, the coordinate points are connected through straight lines to form such a convex shape as to include all of the coordinate points as a convex hull calculation subject C. In a word, any of the coordinate points each indicated by a cross mark (x) is not included in the convex hull calculation subject C, but the coordinate points each indicated by a black circle mark () are included in the convex hull calculation subject C. The convex hull calculation subject C is represented by a coordinate point column of the pitch values p, and the yaw values y.

In general, for calculating the convex hull, at least three coordinate points are required. Therefore, the direction dispersion determination processing section 25 does not carry out the convex hull calculation until the peripheral direction determination processing section 24 determines three sheets of face images as the registration candidates of the peripheral direction, and holds therein the pitch values p, and the yaw values y, which are obtained from these face images. Also, when the peripheral direction determination processing section 24 determines four sheets of face images as the registration candidates of the peripheral direction, the direction dispersion determination processing section 25 carries out the convex hull calculation, and holds therein a convex hull calculation subject C^{new} which is newly obtained from the convex hull calculation. After that, whenever the peripheral direction determination processing section 24 determines a new registration candidate of the peripheral direction, the direction dispersion determination processing section 25 repetitively carries out the convex hull calculation by using both of the pitch value p, and the yaw direction, y, which are obtained from the new face image.

After the direction dispersion determination processing section 25 has carried out the convex hull calculation, the direction dispersion determination processing section 25 calculates a convex hull area S_{ch} as an area of the polygon formed by the convex hull, and holds therein a convex hull maximum area Sₜₕ^{max} becoming a maximum area. Also, when the direction dispersion determination processing section 25 carries out newly the convex hull calculation, the direction dispersion determination processing section 25 repetitively updates the convex hull when the new convex hull area S_{ch} is larger than the previous convex hull maximum area Sₜₕ^{max}, thereby carrying out the dispersion of the directions of the subject to registration.

In addition, for example, the direction dispersion determination processing section 25 can adopt processing for previously setting four areas (that is, first to fourth quadrants), selecting one candidate of the peripheral direction in each of the four areas, and carrying out the convex hull calculation based on the four points. In such processing, the direction dispersion determination processing section 25 carries out a determination for a sign of the pitch value p and the yaw value y to determine which of the four areas the coordinate value indicated by both of the pitch value p, and the yaw value y, belongs to, thereby obtaining one coordinate point P becoming the registration candidate for every area. Also, after the direction dispersion determination processing section 25 has obtained the coordinate point P becoming the registration candidate in each of the four areas, the direction dispersion determination processing section 25 calculates the convex hull area S_{ch} of the convex hull which is formed by the four coordinate points P in the four areas. After that, whenever the peripheral direction determination processing section 24 determines a new registration candidate of the peripheral direction, the direction dispersion determination processing section 25 carries out the convex hull calculation by using the five points including the new coordinate point P, selects the coordinate points P defining the large convex hull area S_{ch}, and repetitively carries out the update of the convex hull.

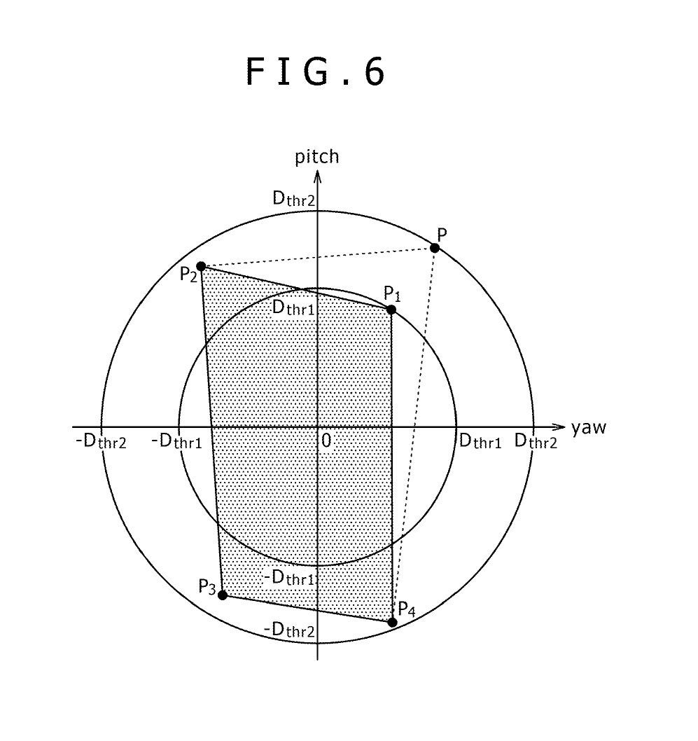

For example, it is supposed that, for example, the coordinate point P₁ in the first quadrant, the coordinate point P₂ in the second quadrant, the coordinate point P₃ in the third quadrant, and the coordinate point P₄ in the fourth quadrant are held as the convex hull calculation subject C. At this time, an area of the area which is hutched in FIG. 6 is the convex hull area S_{ch}, of the convex hull calculation subject C, surrounded by the coordinate points P₁ to P₄, and is also the convex hull maximum area Sₜₕ^{max} at this time point.

Now, when the peripheral direction determination processing section 24 determines the new registration candidate of the peripheral direction, the direction dispersion determination processing section 25 carries out the determination for the sign of the pitch value p, and the yaw value y, which are obtained from the face image as the new registration candidate of the peripheral direction. Also, when as shown in FIG. 6, the coordinate point P represented by both of the new pitch value p, and yaw value y, is present in the first quadrant, the direction dispersion determination processing section 25 obtains the convex hull area S_{ch} of the new convex hull calculation subject C^{new} composed of the coordinate point P, and the coordinate points P₂ to P₄. Also, when the convex hull area S_{ch} of the new convex hull calculation subject C^{new} is larger than the convex hull area S_{ch} of the convex hull calculation subject C composed of the coordinate points P₁ to P₄, the direction dispersion determination processing section 25 updates the convex hull. That is to say, the direction dispersion determination processing section 25 determines the new convex hull calculation subject C^{new} as the convex hull calculation subject C, and sets the convex hull area S_{ch} of the new convex hull calculation subject C^{new} as the convex hull maximum area Sₜₕ^{max}.

In such a manner, the peripheral direction determination processing section 24 repetitively executes the processing for updating the convex hull calculation subject C in such a way that the convex hull area S_{ch} spreads, thereby making it possible to disperse the directions of the face of the subject to registration.

Now, even when in the process of calculating the convex hull by the direction dispersion determination processing section 25, the coordinate points P₁ to P₄ are set in the first to fourth quadrants, respectively, it is feared that the direction of the face of the subject to registration are not mutually, sufficiently dispersed.

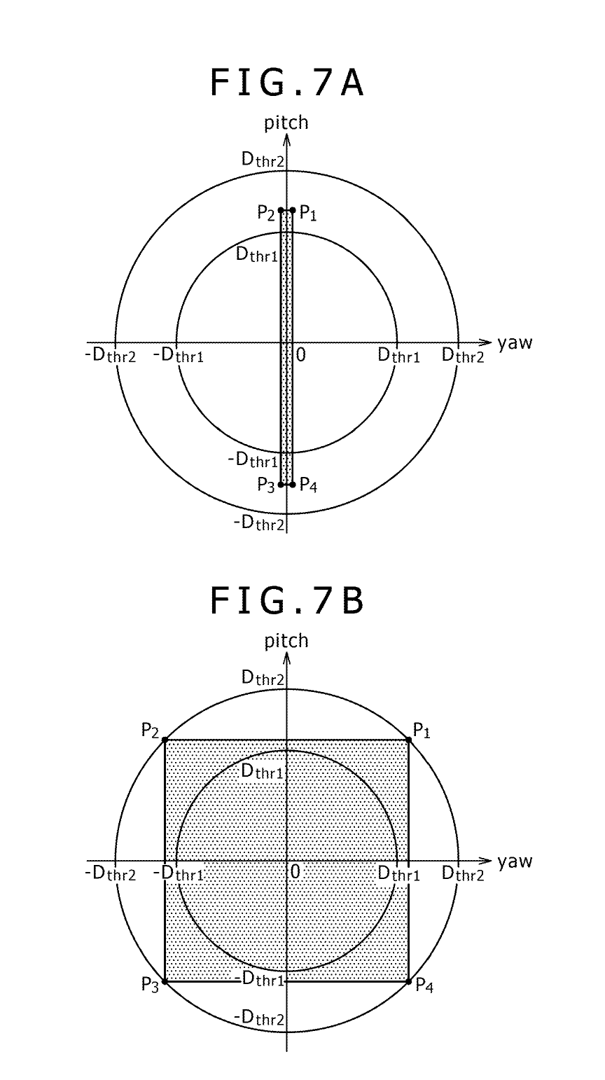

For example, when as shown in FIG. 7A, the face of the subject to registration is largely changed only in the pitch direction, but is not changed in the yaw direction at all, it becomes difficult to carry out the highly-precise face authentication. Then, the direction dispersion determination processing section 25 sets a convex hull area threshold value S_{ch}^{thr} for the convex hull area S_{ch}, and repetitively updates the convex hull until the convex hull area S_{ch} becomes equal to or larger than the convex hull area threshold value S_{ch}^{thr}. As a result, it is avoided that the convex hull concerned becomes the convex hull as shown in FIG. 7A, and thus it is possible to acquire the face images in which the directions of the face of the subject to registration are mutually, sufficiently dispersed.

For example, as shown in FIG. 7B, it becomes the most ideal convex hull to acquire such coordinate points P₁ to P₄ as to become apices of a quadrangle which is inscribed in the circle having the square root (Dₜₕᵣ₂)of the second direction scale threshold value D²ₜₕᵣ₂ as the radius.

Also, the direction dispersion determination processing section 25 determines the face images from which the pitch values p, and the yaw values y, representing the coordinate points P₁ to P₄ included in the convex hull calculation subject C of the convex hull area S_{ch} which becomes equal to or larger than the convex hull area threshold value S_{ch}^{thr} as the face images for registration of the peripheral direction.

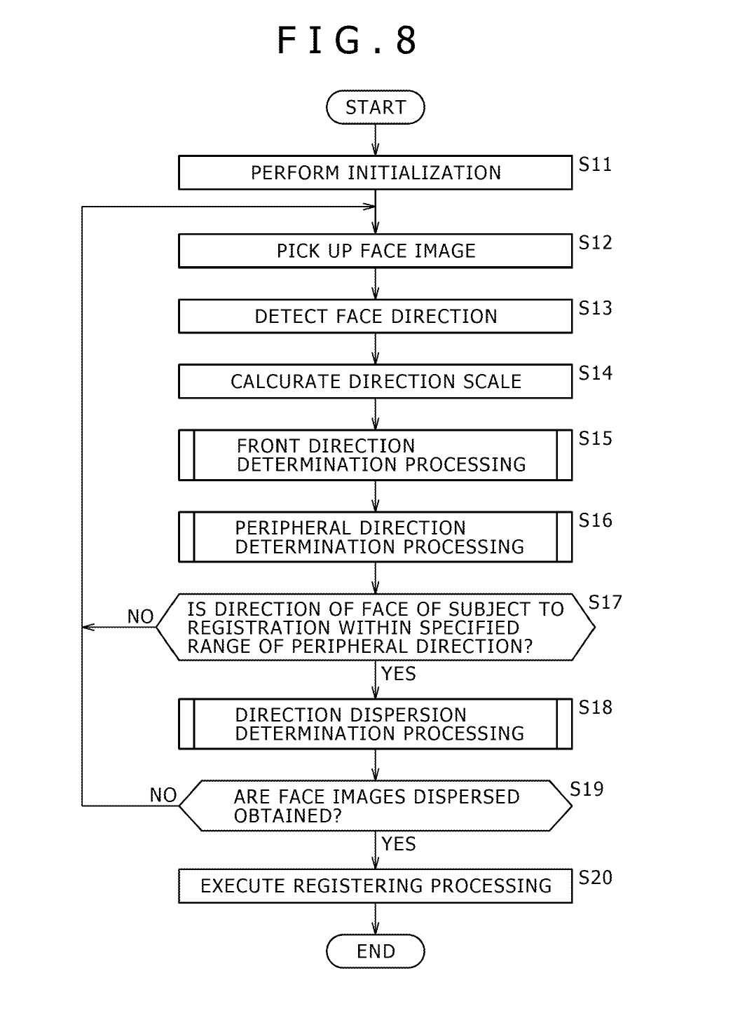

Next, a description will now be given with respect to the face data registering processing executed in the face data registration processing portion 15 with reference to a flow chart shown in FIG. 8.

For example, when the subject to registration carries out a manipulation for the information processor 11 so as to execute the face data registering processing, in processing in Step S11, initialization is carried out in the face registration processing section 15. For example, in the processing in Step S11, the direction dispersion determination processing section 25 initializes both of a convex hull calculation subject count value n_{ch} and the maximum convex hull area S_{ch}^{max} as parameters used in the convex hull calculation to set each of the convex hull calculation subject count value n_{ch} and the maximum convex hull area S_{ch}^{max} to zero in the direction dispersion determination processing.

In processing in Step S12, the image pickup portion 12 picks up the face image and supplies the data on the face image thus picked up to the image holding section 21.

In processing in Step S13, the face direction detecting section 22 reads out the data on the face image becoming the subject of determination from the image holding section 21 to detect the face direction of the face image concerned, thereby obtaining both of the pitch value p, and the yaw value y.

In processing in Step S14, the face direction detecting section 22 calculates the direction scale D² (D²=p²+y²) from both of the pitch value p, and the yaw value y, which are detected in the processing in Step S13. Also, the face direction detecting section 22 supplies the direction scale D² thus calculated to each of the front direction determination processing section 23 and the peripheral direction determination processing section 24.

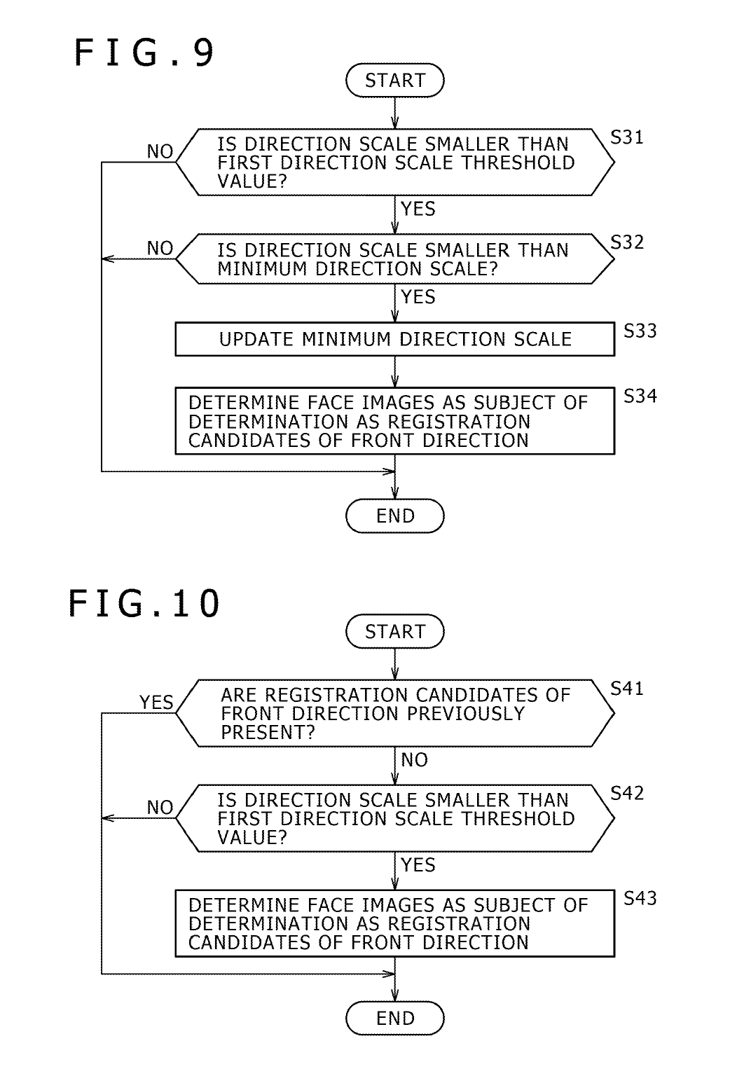

In processing in Step S15, the front direction determination processing section 23 executes the front direction determination processing for determining whether or not the face of the subject to registration in the face image as the subject of determination faces the front direction (refer to FIG. 9 or FIG. 10).

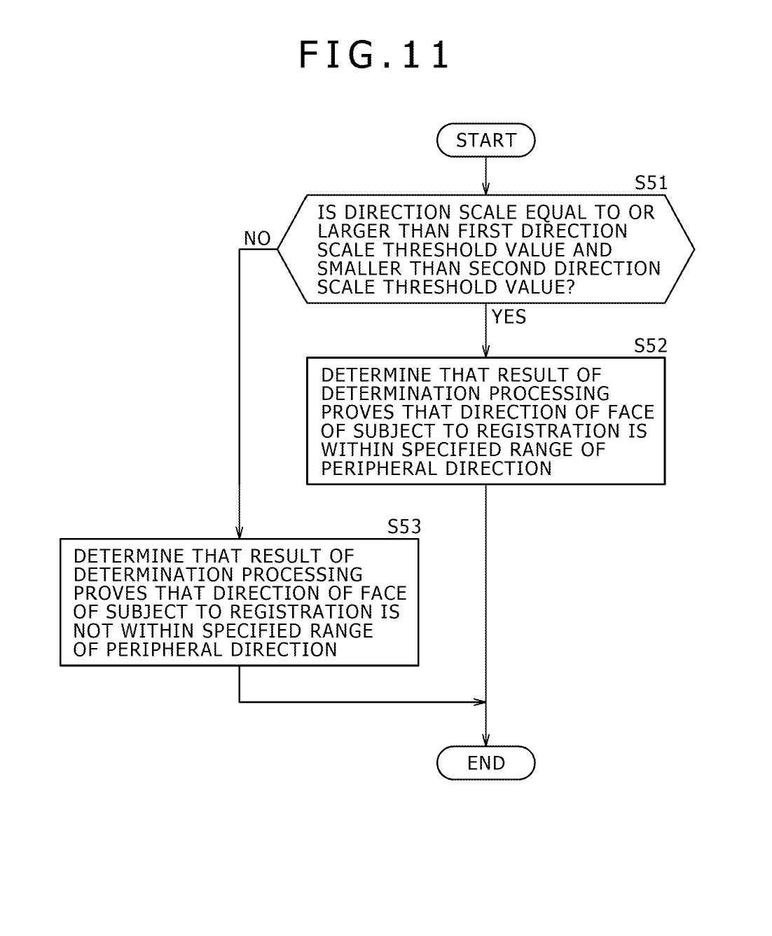

In processing in Step S16, the peripheral direction determination processing section 24 executes the peripheral direction determination processing for determining whether or not the direction of the face of the subject to registration in the face image as the subject of determination is within the suitable specified range of the peripheral direction which is such that the recognition precision is not reduced in the face recognition (refer to FIG. 11).

In processing in Step S17, the peripheral direction determination processing section 24 determines whether or not the direction of the face of the subject to registration is within the specified range of the peripheral direction in the face recognition based on the result of execution of the peripheral direction determination processing in the processing in Step S16.

When the peripheral direction determination processing section 24 determines in the processing in Step S17 that the direction of the face of the subject to registration is not within the specified range of the peripheral direction, the operation returns back to the processing in Step S12, and the same pieces of processing are then repetitively executed. On the other hand, when the peripheral direction determination processing section 24 determines in the processing in Step S17 that the direction of the face of the subject to registration is within the specified range of the peripheral direction, the operation proceeds to processing in Step S18.

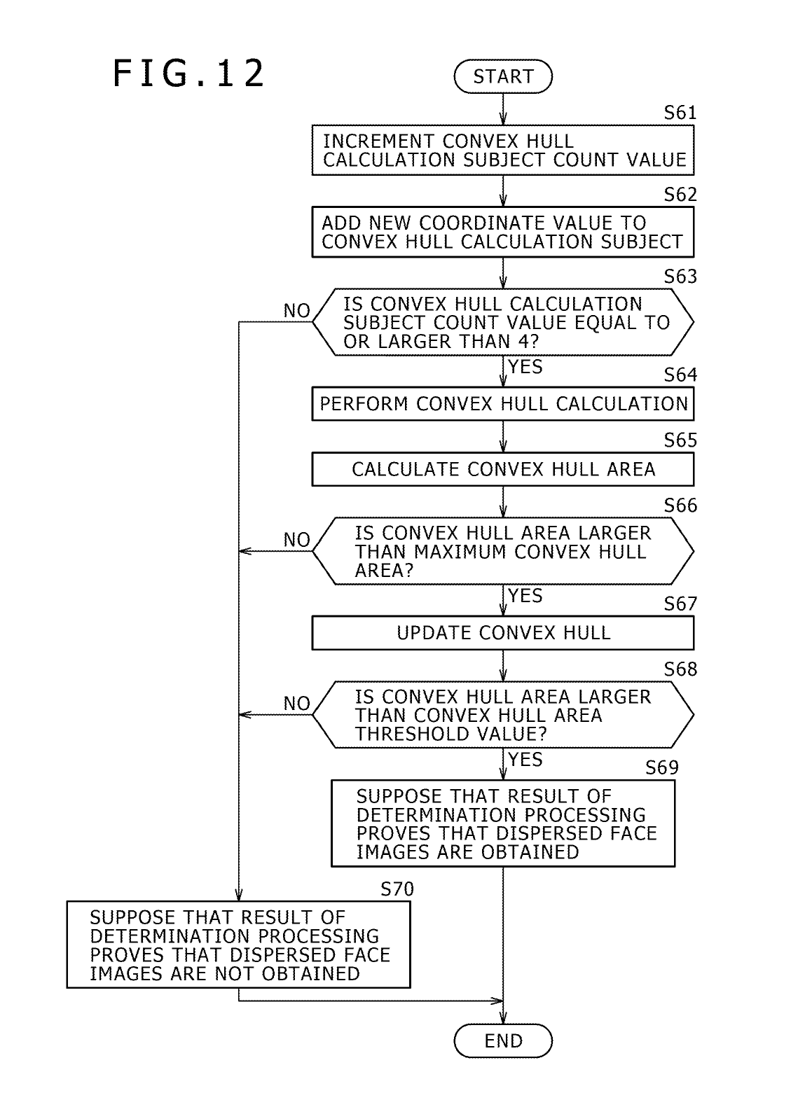

In the processing in Step S18, the direction dispersion determination processing section 25 executes the direction dispersion determination processing for determining whether or not the directions of the face of the subject to registration are mutually, sufficiently dispersed (refer to FIG. 12).

In processing in Step S19, the direction dispersion determination processing section 25 determines whether or not the face images in which the directions of the face of the subject to registration are mutually, sufficiently dispersed are obtained based on the result of execution of the direction dispersion determination processing in the processing in Step S18.

When the direction dispersion determination processing section 25 determines in the processing in Step S19 that the face images in which the directions of the face of the subject to registration are mutually, sufficiently dispersed are not obtained, the operation returns back to the processing in Step S12, and the same pieces of processing are then repetitively executed. On the other hand, when the direction dispersion determination processing section 25 determines in the processing in Step S19 that the face images in which the directions of the face of the subject to registration are mutually, sufficiently dispersed are obtained, the operation proceeds to processing in Step S20.

In the processing in Step S20, the registration processing section 26 calculates an amount of features from both of the face images which the front direction determination processing section 23 determines as the registration candidates of the front direction, and the face images for registration of the peripheral direction which the direction dispersion determination processing section 25 determines. Also, the registration processing section 26 executes the registering processing for supplying the face data composed of the amount of features to the storage portion 13, and causing the storage portion 13 to store therein the face data thus supplied, and then the face data registering processing ends.

Next, FIG. 9 is a flow chart explaining the front direction determination processing in the processing in Step S15 shown in FIG. 8.

In processing in Step S31, the front direction determination processing section 23 determines whether or not the direction scale D² calculated in the processing in Step S14 shown in FIG. 8 is smaller than the first direction scale threshold value D²ₜₕᵣ₁. When the front direction determination processing section 23 determines in the processing in Step S31 that the direction scale D² is smaller than the first direction scale threshold value D²ₜₕᵣ₁, the operation proceeds to processing in Step S32.

In processing in Step S32, the front direction determination processing section 23 determines whether or not the direction scale D² is smaller than a minimum direction scale D²ₘᵢₙ. Here, a minimum value of the direction scales D² each of which is determined to be smaller than the first direction scale threshold value D²ₜₕᵣ₁ in the previous front direction determination processing when the front direction determination processing are repetitively executed is set as the minimum direction scale D²ₘᵢₙ. It is noted that since the minimum direction scale D²ₘᵢₙ is not set in the front direction determination processing, in the first processing in Step S32, the front direction determination processing section 23 determines that the direction scale D² is smaller than the minimum direction scale D²ₘᵢₙ.

When the front direction determination processing section 23 determines in the processing in Step S32 that the direction scale D² is smaller than the minimum direction scale D²ₘᵢₙ, the operation proceeds to processing in Step S33. Then, the front direction determination processing section 23 sets the direction scale D² as the subject of determination to the minimum direction scale D²ₘᵢₙ, thereby updating the direction scale D².

In processing in Step S34, the front direction determination processing section 23 causes the image holding section 21 to preserve therein the data on the face images, as the subject of determination, which are set in the minimum direction scale D²ₘᵢₙ as the data on the registration candidate of the front direction.

After completion of the execution of the processing in Step S34, either when it is determined in the processing in Step S31 that the direction scale D² is not smaller than the first direction scale threshold value D²ₜₕᵣ₁, or when it is determined in the processing in Step S32 that the front direction determination processing section 23 determines that the direction scale D² is not smaller than the minimum direction scale D²ₘᵢₙ, the front direction determination processing ends.

In such a manner, the front direction determination processing section 23 executes the front direction determination processing whenever the face image is picked up, and updates the registration candidates of the front direction in such a way that the direction scale D² becomes the smaller face image, thereby making it possible to register the face data on the face which further faces the front. It is noted that for the purpose of simplifying the processing, after once the face images becoming the registration candidates of the front direction has been determined, the front direction determination processing section 23 can execute the processing so as not to update the registration candidates of the front direction.

Next, FIG. 10 is a flow chart explaining another example of the front direction determination processing in the processing in Step S15 shown in FIG. 8.

In processing in Step S41, the front direction determination processing section 23 determines whether or not the face images becoming the registration candidates of the front direction are previously present. When it is determined in the processing in Step S41 that the face images becoming the registration candidates of the front direction are not present, the operation proceeds to processing in Step S42.

In the processing in Step S42, similarly to the case of the processing in Step S32 shown in FIG. 9, the front direction determination processing section 23 determines whether or not the direction scale D² is smaller than the minimum direction scale D²ₘᵢₙ. When it is determined in the processing in Step S42 that the direction scale D² is smaller than the minimum direction scale D²ₘᵢₙ, the operation proceeds to processing in Step S43.

In the processing in Step S43, the front direction determination processing section 23 causes the image holding section 21 to preserve therein the data on the face images, as the subject of determination, each corresponding to the direction scale D² which is determined to be smaller than the minimum direction scale D²ₘᵢₙ as the data on the registration candidates of the front direction.

After completion of the execution of the processing in Step S43, either when it is determined in the processing in Step S41 that the face images becoming the registration candidates of the front direction are previously present, or when it is determined in the processing in Step S42 that the direction scale D² is not smaller than the minimum direction scale D²ₘᵢₙ, the front direction determination processing ends.

In such a manner, after once the face images becoming the registration candidates of the front direction have been determined, the front direction determination processing section 23 does not carry out the update of the registration candidates of the front direction, whereby the processing is simplified and thus it is possible to reduce the load imposed on the system.

Next, FIG. 11 is a flow chart explaining the peripheral direction determination processing in the processing in Step S16 shown in FIG. 8.

In processing in Step S51, the peripheral direction determination processing section 24 determines whether or not the direction scale D² calculated in the processing in Step S14 shown in FIG. 8 is equal to or larger than the first direction scale threshold value D₂ₜₕᵣ₁ and is smaller than the second direction scale threshold value D²ₜₕᵣ₂.

When the peripheral direction determination processing section 24 determines in the processing in Step S51 that the direction scale D² is equal to or larger than the first direction scale threshold value D²ₜₕᵣ₁ and is smaller than the second direction scale threshold value D²ₜₕᵣ₂, the operation proceeds to processing in Step S52. In the processing in Step S52, the peripheral direction determination processing section 24 determines that the result of the determination processing proves that the direction of the face of the subject to registration is within the specified range of the peripheral direction, and determines the face image as the subject of registration as the registration candidate of the peripheral direction.

On the other hand, when the peripheral direction determination processing section 24 determines in the processing in Step S51 that the direction scale D² is not equal to or larger than the first direction scale threshold value D²ₜₕᵣ₁, and is not smaller than the second direction scale threshold value D²ₜₕᵣ₂, the operation proceeds to processing in Step S53. That is to say, either when the direction scale D² is smaller than the first direction scale threshold value D²ₜₕᵣ₁, or when the direction scale D² is equal to larger than the second direction scale threshold value D²ₜₕᵣ₂, the operation proceeds to the processing in Step S53. In the processing in Step S53, the peripheral direction determination processing section 24 determines that the result of the determination result proves that the direction of the face of the subject to registration is not within the specified range of the peripheral direction.

After completion of the execution of the processing in Step S52 or in Step S53, the peripheral direction determination processing ends.

Next, FIG. 12 is a flow chart explaining the direction dispersion determination processing in the processing in Step S18 shown in FIG. 8.

In processing in Step S61, the direction dispersion determination processing section 25 increments a convex hull calculation subject count value n_{ch} obtained by counting the number of coordinate points included in the convex hull calculation subject C (n_{ch}=n_{ch}+1).

In processing in Step S62, the direction dispersion determination processing section 25 acquires both of the pitch value p and the yaw value y obtained from the face image which is determined as the new registration candidate of the peripheral direction by the peripheral direction determination processing section 24 from the detecting portion 22. Also, the direction dispersion determination processing section 25 holds therein a convex hull calculation subject C^{new} which is obtained by adding the coordinate point represented by both of the pitch value p, and the yaw value y, which are newly acquired to the current convex hull calculation subject C.

In processing in Step S63, the direction dispersion determination processing section 25 determines whether or not the current convex hull calculation subject count value n_{ch} is equal to or larger than 4. When the direction dispersion determination processing section 25 determines in the processing in Step S63 that the current convex hull calculation subject count value n_{ch} is equal to or larger than 4 (n_{ch}≧4), the operation proceeds to processing in Step S63.

In processing in Step S64, the direction dispersion determination processing section 25 carries out the convex hull calculation by using the convex hull calculation subject C^{new}. Then, in the processing in Step S65, the direction dispersion determination processing section 25 calculates the convex hull area S_{ch} of the convex hull which is obtained in the processing in Step S63.

In processing in Step S66, the direction dispersion determination processing section 25 determines whether or not the convex hull area S_{ch} calculated in the processing in Step S65 is larger than the convex hull maximum area Sₜₕ^{max}. When the direction dispersion determination processing section 25 determines in the processing in Step S66 that the convex hull area S_{ch} calculated in the processing in Step S65 is larger than the convex hull maximum area Sₜₕ^{max} (S_{ch}>Sₜₕ^{max}), the operation proceeds to processing in Step S67.

In the processing in Step S67, the direction dispersion determination processing section 25 updates the convex hull. Also, the direction dispersion determination processing section 25 determines the convex hull calculation subject C^{new} obtained in the processing in Step S63 as the convex hull calculation subject C, and determines the convex hull area S_{ch} calculated in the processing in Step S64 as the convex hull maximum area Sₜₕ^{max}.

In processing in Step S68, the direction dispersion determination processing section 25 determines whether or not the convex hull area S_{ch} calculated in the processing in Step S64 is equal to or larger than a convex hull area threshold value S_{ch}^{thr}. When the direction dispersion determination processing section 25 determines in the processing in Step S68 that the convex hull area S_{ch} calculated in the processing in Step S64 is equal to or larger than a convex hull area threshold value S_{ch}^{thr} (S_{ch}≧S_{ch}^{thr}), the operation proceeds to processing in Step S69.

In the processing in Step S69, the direction dispersion determination processing section 25 determines that the result of the determination processing proves that the face images in which the directions of the faces of the subject to registration are mutually, sufficiently dispersed are obtained.

On the other hand, when it is determined in the processing in Step S63 that the current convex hull calculation subject count value n_{ch} is not equal to or larger than 4, when it is determined in the processing in Step S66 that the convex hull area S_{ch} is not lager than the convex hull maximum area S_{ch}^{max} (the convex hull area S_{ch} is equal to or smaller than the convex hull maximum area S_{ch}^{max}), or when it is determined in the processing in Step S68 that the convex hull area S_{ch} is not equal to larger than the convex hull area threshold value S_{ch}^{thr} (the convex hull area S_{ch} is smaller than the convex hull area threshold value S_{ch}^{thr}), the operation proceeds to processing in Step S70. In the processing in Step S70, the direction dispersion determination processing section 25 determines that the result of the determination processing proves that the face images in which the directions of the faces of the subject to registration are mutually, sufficiently dispersed are not obtained.

After completion of the execution of the processing in Step S69 or in Step S70, the direction dispersion determination processing ends.

As described above, in the information processor 11, for example, the message representing the effect that the face images of the face in the front direction and in arbitrary direction should be continuously picked up is only displayed for the subject to registration on the display portion 14, whereby the face images used to stably carry out the face authentication can be readily acquired. In particular, in the information processor 11, it is possible to acquire both of the face image facing the front direction, and the predetermined sheets of face images which face the peripheral direction and thus in which the directions are mutually dispersed. Therefore, it is possible to enhance the precision of the face authentication processing.

Therefore, it is only necessary for the subject to registration to move his/her face freely, which makes it possible to register the face data. Also, although the information processor 11 instructs the subject to registration to change the direction of his/her face as with the related art, it is possible to exclude the influence of such as the level of skill of the instruction.

Now, it is also supposed that even when the subject to registration freely moves his/her face, it may be impossible to acquire the ideal convex hull. In order to cope with this situation, in the information processor 11, for example, the image of the convex hull area S_{ch} of the convex hull calculation subject C as shown in FIG. 6 is displayed on the display portion 14, whereby the subject to registration can move his/her face in such a way that the ideal convex hull can be acquired.

That is to say, as shown in FIG. 13, the display portion 14 is dispersed so as to confront directly the front of the subject to registration. Thus, a quadrangle (convex hull) which is formed by disposing the coordinate points corresponding to the face image determined as the registration candidate in the direction dispersion determination processing on the yaw and pitch coordinate space can be displayed on the display portion 14. Also, in the information processor 11, the process that in correspondence to that the subject to registration change his/her face direction, the convex hull calculation subject C is updated in the direction dispersion determination processing, and the quadrangle formed by the coordinate points displayed on the display portion 14 is deformed is visually displayed on the display portion 14.

At this time, the message suggesting that the face is moved in such a way that the area of the quadrangle formed by the coordinate points displayed on the display portion 14 is increased is only displayed on the display portion 14, whereby it is possible to acquire the objective ideal convex hull, that is, it is possible to pick up the face images in which the directions are dispersed.

In addition, the peripheral direction determination processing 24 may set limits on the suitable specified range of the peripheral direction which is such that the recognition precision is not reduced in the face recognition based on the quadrant or the angle, and thus the data on the images determined as the registration candidates of the peripheral direction may be preserved every quadrant or angle of the specified range. As a result, it is possible to stably urge the subject to registration to move the face for directional dispersion.

It is noted that although in the embodiment of the present disclosure, the description has been given with respect to the processing for determining the direction of the face by using both of the pitch value p and the yaw value y, processing for determining the direction of the face, including the roll value r, may also be executed. In this case, the processing is three-dimensionally executed. Thus, a calculation is carried out by using a stereoscopic polyhedron instead of using the polygon based on the two-dimensional convex hull. In addition, the direction scale D² which is used in the front direction determination processing and the peripheral direction determination processing is calculated from D²=p²+y²+r², including the roll value r.

In addition, in the information processor 11, in addition to the data on the images picked up by the image pickup portion 12, for example, the data on the images which are previously picked up by the image pickup portion 12 is supplied to the face data registration processing portion 15 and thus the face image of the desired direction can be acquired from these images. Therefore, the information processor 11 can acquire the face images in which the directions are dispersed as much as possible from the continuous images as well for which it is not conscious to register the images for the face authentication.

In accordance with a program according to one embodiment of the present disclosure, a computer executes processing including the steps of: detecting the directions of the face from images in which the face of the subject to registration becoming the subject of the registration is photographed; determining the images for which the directions of the face detected are determined to be within the specified range of the predetermined peripheral direction other than the front surface direction as the registration candidates of the peripheral direction; and determining the predetermined sheets of images, for which the directions of the face are sufficiently, mutually dispersed, of the images determined as the registration candidates as the images for registration of the peripheral direction (refer to FIGS. 8 to 12).

In addition, the present disclosure not only can be used in a face data registering processor used in the face authentication system, but also can be used in a personal apparatus for which the user authentication is required like a smartphone or the like.

It is noted that the predetermined pieces of processing which have been described with reference to the flow charts described above are not necessarily executed in a time series manner in accordance with the order described in the form of the flow charts, and thus includes predetermined pieces of processing which are executed in parallel or individually (for example, parallel processing or processing by an object). In addition, the program may be either one which is executed by one CPU or one which is dispersively executed by plural CPUs.

In addition, the series of processing described above (information processing method) can be executed either by hardware or by software. When the series of processing are executed by the software, a program composing the software is installed from a program recording medium in which a program is recorded in a computer which is incorporated in dedicated hardware, in a computer which can carry out various kinds of functions by installing therein various kinds of programs, for example, a general-purpose personal computer or the like.

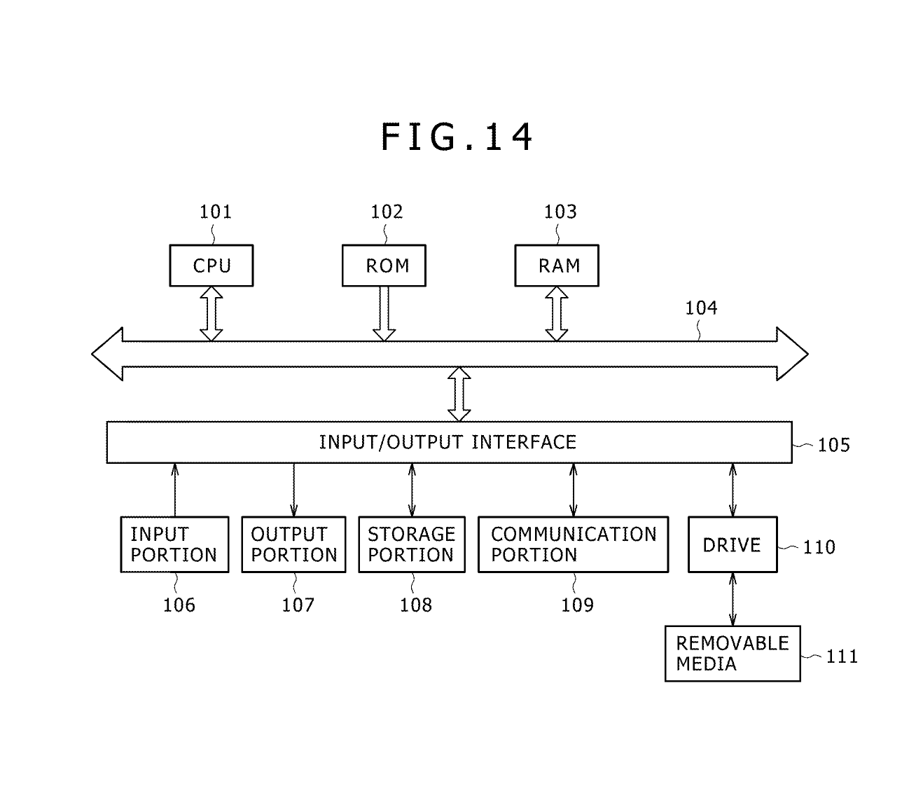

FIG. 14 is a block diagram showing a configuration of hardware of a computer for executing the series of processing described above in accordance with a program.

In the computer, a Central Processing Unit (CPU) 101, a Read Only Memory (ROM) 102, and a Random Access Memory (RAM) 103 are connected to one another through a bus 104.

An input/output interface 105 is further connected to the bus 104. An input portion 106 composed of a keyboard, a mouse, a microphone, or the like, an output portion 107 composed of a display device, a speaker, or the like, a storage portion 108 composed of a hard disc, a non-volatile memory, or the like, a communication portion 109 composed of a network interface or the like, and a drive 110 for driving a removable media 111 such as a magnetic disc, an optical disc, a magneto optical disc, or a semiconductor memory are connected to the input/output interface 105.

With the computer configured in the manner as described above, for example, the CPU 101 loads the program stored in the storage portion 108 into the RAM 103 through the input/output interface 105 and the bus 104 in order to execute the program, thereby executing the series of processing described above.

The program which the computer (the CPU 101) executes, for example, can be recorded in a removable media 111 as a package media composed of a magnetic disc (including a flexible disc), an optical disc (such as a Compact Disc-Read Only Memory (CD-ROM) or a Digital Versatile Disc (DVD)), a magneto optical disc, a semiconductor memory or the like to be provided. Or, the program is provided through a wired or wireless transmission media such as a Local Area Network (LAN), the Internets, or the digital satellite broadcasting.

The program can be installed in the storage portion 108 through the input/output interface 105 by mounting the removable media 111 to the drive 110. In addition, the program can be received at the communication portion 109 through the wired or wireless transmission media to be installed in the storage portion 108. In addition thereto, the program can be previously installed either in the ROM 102 or in the storage portion 108.

It is noted that the present disclosure can also adopt the following constitutions.

(1) An information processor including:

a face direction detecting section configured to detect directions of a face from images in which the face of a subject to registration becoming a subject of registration is photographed;

a peripheral direction determination processing section configured to determine the images for which the directions of the face detected by the face direction detecting section is determined to be within a specified range of a predetermined peripheral direction other than a front surface direction as registration candidates of the peripheral direction; and

a direction dispersion determination processing section configured to determine the predetermined sheets of images, for which the directions of the face are sufficiently, mutually dispersed, of the images determined as the registration candidates by the peripheral direction determination processing section as the images for registration of the peripheral direction.

(2) The information processor described in the paragraph (1), further including

a front direction determination processing section configured to determine the image for which the direction of the face detected by the face direction detecting section is determined to be the front direction as a registration candidate of the front direction.

(3) The information processor described in the paragraph (1) or (2), in which when a sum of squares of a pitch value and a yaw value which represent the direction of the face detected by the face direction detecting section is smaller than a predetermined first threshold value, the front direction determination processing section determines that the direction of the face of the image is the front direction.

(4) The information processor described in any one of the paragraphs (1) to (3), in which when the sum of squares of the pitch value and the yaw value which represent the direction of the face detected by the face direction detecting section is equal to or larger than the predetermined first threshold value and is smaller than a second threshold value larger than the predetermined first threshold value, the peripheral direction determination processing section determines that the direction of the face of the image is within the specified range of the peripheral direction.

(5) The information processor described in any one of the paragraphs (1) to (4), in which the direction dispersion determination processing section calculates a convex hull including a coordinate point represented by a pitch value and a yaw value which represent the direction of the face in the image determined as the registration candidate by the peripheral direction determination processing section, and updates the convex hull in such a way that an area of the convex hull becomes large whenever the image is determined as the registration candidate by the peripheral direction determination processing section.

(6) The information processor described in the paragraph (5), in which when the area of the convex hull is equal to or larger than a predetermined threshold value, the direction dispersion determination processing section determines that the directions of the face are mutually, sufficiently dispersed.

(7) The information processor described in the paragraph (5) or (6), further including

a display portion configured to dispose and display a polygon formed by the coordinate points which the direction dispersion determination processing section determines as subjects of calculation of the convex hull on a coordinate space.

(8) The information processor described in any one of the paragraphs (1) to (7), further including

a registration processing section configured to calculate an amount of features from the face photographed in the image of the peripheral direction determined as an image for registration by the direction dispersion determination processing section, and register the amount of features thus calculated.

(9) The information processor described in any one of the paragraphs (1) to (8), in which the peripheral direction determination processing section sets limits based on a quadrant or an angle of the specified range, and sets the image determined as a candidate of the peripheral direction every quadrant or angle of the specified range.

It is to be noted that the embodiment of the present disclosure is not limited to the foregoing embodiment, and that various changes can be made without departing from the spirit of the present disclosure.

The present technology contains subject matter related to that disclosed in Japanese Priority Patent Application JP 2012-112459 filed in the Japan Patent Office on May 16, 2012, the entire content of which is hereby incorporated by reference.

What is claimed is:

1. An information processor, comprising:
a face direction detecting section configured to detect directions of a face from images in which said face of a subject to registration becoming a subject of registration is photographed;
a peripheral direction determination processing section configured to determine the images for which the directions of said face detected by said face direction detecting section are determined to be within a specified range of a predetermined peripheral direction other than a front surface direction as registration candidates of the peripheral direction; and
a direction dispersion determination processing section configured to determine the predetermined sheets of images, for which the directions of said face are sufficiently, mutually dispersed, of the images determined as said registration candidates by said peripheral direction determination processing section as the images for registration of the peripheral direction.

2. The information processor according to claim 1, further comprising
a front direction determination processing section configured to determine the image for which the direction of said face detected by said face direction detecting section is determined to be the front direction as a registration candidate of the front direction.

3. The information processor according to claim 2, wherein which when a sum of squares of a pitch value and a yaw value which represent the direction of said face detected by said face direction detecting section is smaller than a predetermined first threshold value, said front direction determination processing section determines that the direction of said face of the image is the front direction.

4. The information processor according to claim 3, wherein when the sum of squares of the pitch value and the yaw value which represent the direction of said face detected by said face direction detecting section is equal to or larger than the predetermined first threshold value and is smaller than a second threshold value larger than the predetermined first threshold value, said peripheral direction determination processing section determines that the direction of said face of the image is within the specified range of the peripheral direction.

5. The information processor according to claim 1, wherein said direction dispersion determination processing section calculates a convex hull including a coordinate point represented by a pitch value and a yaw value which represent the direction of said face in the image determined as the registration candidate by said peripheral direction determination processing section, and updates the convex hull in such a way that an area of the convex hull becomes large whenever the image is determined as the registration candidate by said peripheral direction determination processing section.

6. The information processor according to claim 5, wherein when the area of the convex hull is equal to or larger than a predetermined threshold value, said direction dispersion determination processing section determines that the directions of said face are mutually, sufficiently dispersed.

7. The information processor according to claim 5, further comprising
a display portion configured to dispose and display a polygon formed by the coordinate points which said direction dispersion determination processing section determines as subjects of calculation of the convex hull on a coordinate space.

8. The information processor according to claim 1, further comprising
a registration processing section configured to calculate an amount of features from said face photographed in the image of the peripheral direction determined as an image for registration by said direction dispersion determination processing section, and register the amount of features thus calculated.

9. The information processor according to claim 1, wherein said peripheral direction determination processing section sets limits based on a quadrant or an angle of the specified range, and sets the image determined as a candidate of the peripheral direction every quadrant or angle of the specified range.

10. An information processing method, comprising:
detecting directions of a face from images in which said face of a subject to registration becoming a subject of registration is photographed;
determining the images for which the directions of said face detected are determined to be within a specified range of a predetermined peripheral direction other than a front surface direction as registration candidates of the peripheral direction; and
determining the predetermined sheets of images, for which the directions of said face are sufficiently, mutually dispersed, of the images determined as said registration candidates as the images for registration of the peripheral direction.

11. A program for causing a computer to execute a process comprising:
detecting directions of a face from images in which said face of a subject to registration becoming a subject of registration is photographed;
determining the images for which the directions of said face detected are determined to be within a specified range of a predetermined peripheral direction other than a front surface direction as registration candidates of the peripheral direction; and
determining the predetermined sheets of images, for which the directions of said face are sufficiently, mutually dispersed, of the images determined as said registration candidates as the images for registration of the peripheral direction.
